(19) United States
(12) Patent Application Publication
(10) Pub. No.: US 2016/0128484 A1
(43) Pub. Date: May 12, 2016

(54) FLEXIBLE SUSPENSION LAMINATE

(71) Applicant: ACME MILLS COMPANY, Bloomfield Hills, MI (US)

(72) Inventors: Neil Gross, Bloomfield Hills, MI (US); James Colman, Bloomfield Hills, MI (US)

(21) Appl. No.: 14/895,828

(22) PCT Filed: Jun. 3, 2014
(86) PCT No.: PCT/US2014/040699

§ 371 Date: Dec. 3, 2015

Related U.S. Application Data
(60) Provisional application No. 61/830,298, filed on Jun. 3, 2013.

(51) Int. Cl. A47C 7/14; D03D 15/00; B60N 2/58

(52) U.S. Cl. CPC A47C 7/14; B60N 2/58; D03D 15/00; D10B 2331/10; D10B 2321/041; D10B 2505/08

(57) ABSTRACT

A flexible suspension laminate is provided that includes a woven base of thermoplastic polyester elastomer filaments interwoven with spun polyester yarn filaments. A skin is bonded to the woven base and has an outer surface textured for contact with a user when the laminate is integrated into a seating system. The skin is formed of a polyisocyanate modified polyurethane, polyester, or poly-vinyl chloride to achieve a warp break strength of greater than 200 Newtons/centimeter and a fill break strength of greater than 200 Newtons/centimeter.

### RELATED APPLICATIONS

This application claims priority benefit of U.S. Provisional Application Ser. No. 61/830,298 filed Jun. 3, 2013; the contents of which are hereby incorporated by reference.

### FIELD OF THE INVENTION

The present invention in general relates to flexible suspension laminates with woven backings and in particular to such laminates having a skin bonded to the woven backings.

### BACKGROUND OF THE INVENTION

Thermoplastic polyester elastomers are a well-known class of materials characterized by both thermoplastic and elastomeric properties. As a result of these attributes, fibers of thermoplastic polyester elastomers have found a variety of uses as cables sheathing, weather stripping, and other places where fabric having both stiffness and abrasion resistance are valued attributes. Exemplary of such materials are those available from the DuPont Company under the trade name HYTREL®. Thermoplastic polyester elastomers are generally prepared from terephthalic acids or esters, polyalkylene C₄-C₁₂ alkyl diols. Poly(tetramethylene ether) glycol and 1,4-butane diol are exemplary polyalkylene ether glycol and an elkhyl diol, respectively. Typical of thermoplastic polyester elastomers are elastomer chains that have two types of recurring units with one unit formed of terephthalic acid glycol while the other unit is formed of terephthalic acid and diol.

Thermoplastic polyester elastomers afford resistance to creep, impact damage and flexural fatigue. Additionally, these elastomers are chemically resistant to many commonly used industrial solvents in the oils thereby making thermoplastic polyester elastomers attractive components for automotive applications such as air intake ducts, hoses and tubes, sheeting for wire and cable, and protective joint boots.

Woven thermoplastic polyester elastomer sheeting is also an attractive component of a seating fabric owing to the elasticity such a thermoplastic polyester elastomer a part of a seating system, as well as the long duration resiliency to such a fabric when exposed to flexural fatigue conditions associated with repeated and prolonged sitting. Unfortunately, the joining of various surface skins to thermoplastic polyester elastomer woven sheets has proven to be technologically difficult owing to property mismatch between a desired surface layer and such sheets; and the inability of exposed thermoplastic polyester elastomer sheeting alone to achieve the necessary compression fatigue resistance needed for seating applications of vehicles and furniture. While attempts to improve bonding of thermoplastic polyester elastomers to various skins has continued, with processing difficulties and the failure to achieve desired overall properties has led to experiments with various types of subunits within the polyester elastomer. In spite of the recognition that considerable reductions in weight and volume would be achieved by supplanting conventional seating components such as foam and springs with an elastomeric fabric based on thermoplastic polyester elastomers, it remains the case that commercial implementation of thermoplastic polyester elastomers with an outer skin or contact with a user remains elusive. At best, some high quality office chairs have a bare thermoplastic polyester elastomeric sheet as a seating surface.

Thus, there exists a need for a flexible suspension laminate including a thermoplastic polyester elastomer backing. There also exists a need for such a laminate in a seating system to reduce the volume and weight of a seating cushion.

### SUMMARY OF THE INVENTION

A flexible suspension laminate is provided that includes a woven base of thermoplastic polyester elastomer filaments interwoven with polyester spun yarn filaments. A skin is bonded to the woven base and has an outer surface textured for contact with a user when the laminate is integrated into a seating system. The skin is formed of polyisocyanate modified polyurethane, polyester, or poly-vinyl chloride to achieve a warp break strength of greater than 200 Newtons/centimeter and a fill break strength of greater than 200 Newtons/centimeter.

### BRIEF DESCRIPTION OF THE DRAWINGS

The present invention is further detailed with respect to exemplary embodiments. It should be appreciated that the present invention is not limited to the specific embodiments detailed in these figures but rather these are provided to illustrate aspects of inventive flexible suspension laminates.

FIG. 1 is an exploded perspective view of an inventive suspension laminate;

FIG. 2 is a cross-sectional view of an inventive laminate with an intermediate layer between a woven base and a skin; and

FIG. 3 is a cross-sectional of an inventive laminate with an intermediate layer between the woven base and the skin in which the intermediate layer penetrates the woven base.

### DESCRIPTION OF THE INVENTION

The present invention has utility as a flexible suspension laminate that is particularly well suited for the requirements of seating systems found in vehicles, mass transit, aviation and furniture. Owing to the high strength resilience durability, a woven base of the laminate, a seat is obtained with superior durability and simplified construction relative to conventional seats.

An inventive flexible suspension laminate includes a woven base of thermoplastic polyester elastomer filaments that are interwoven with spun polyester yarn filaments. A skin is bonded to the woven base and formed from a polyisocyanate modified polyurethane, polyester, polyvinyl chloride to achieve break strengths of greater than 200 Newtons per centimeters (N/cm) and tear strengths in a warp direction of at least 32 N/cm and a tear strength in the fill of at least 28 N/cm. The skin has an outer surface define a seating substrate that can be textured in a way simulative of leather or woven cloth, or textured flock. It has been surprisingly found that through the inclusion of neoprene filaments in the woven base, that superior strength and interfacial bonding are enhanced through the inclusion of the neoprene filaments to achieve overall laminate properties that are superior to conventional materials and suitable for implement in efficient manufacture of seats from a thermoplastic polyester elastomer.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

A woven base according to the present invention is formed of woven thermoplastic polyester elastomers that are formed into a woven fabric. It is appreciated that a filament of a woven base is either a monofilament; or from a twisted bundle of fibers that collectively form a filament; synonymously referred to herein as a “yarn” or a “yarn filament”. It is appreciated that a yarn is formed of multiple bundled or twisted fibers; in which individual fibers are all formed of like composition of the bundle of fibers vary in composition within a filament. Monofilaments operative in the present invention are either compositional uniform in cross-section or alternatively, have a coaxial compositional difference. In a specific embodiment, a coaxial monofilament has a high melt temperature polyester core with a lower melting temperature sheath fused to the core composition. While weave densities are typically in the range from 10 to 300 weft threads per inch. A tighter weave base tends to impart higher tensile strength to the resultant base material. It is appreciated that a woven base is also readily prepared in certain inventive embodiments to include fibers form of materials illustratively including polyamides, polypropylene, polyaramides, and combinations thereof.

A filament of inventive woven base typically has a diameter of between 0.15 and 1.5 millimeters (mm) and in specific embodiments filament diameter is between 0.3 and 0.8 mm. In addition to filaments of a woven base also include in certain embodiments additional additives such as dyes, pigments, UV stabilizers, plasticizers, flame retardants, antimicrobials, nanoparticles, or combinations thereof. It is appreciated that nanoparticles such as those formed of rutile upon exposure to ultraviolet light afford a degree of self-cleaning, disinfection, and UV protection to the underlying inventive laminate.

A skin is bonded to the woven base to expose an outer surface intended for contact with a user as part of a seating system. The skin is formed of a polyisocyanate modified polyurethane, polyester, or polyvinyl chloride to achieve a warp break strength of greater than 200 N/cm and a fill break strength also of greater than 200 N/cm. An inventive laminate in certain embodiments for seating systems also has warp and fill tear strengths of greater than 32 N/cm and 28 N/cm, respectively. The ability to form a strong bond between the skin and the woven base while still maintaining the strength and resiliency properties of the woven base constitutes a significant improvement of the present invention over the prior art. In specific inventive embodiments, the skin is bonded to the underlying woven base independent of an intermediate contact adhesive. The skin is readily formed with an outer surface having a variety of forms illustratively including a texture simulative of leather or woven cloth, napped flock, or non-napped flock. A typical thickness for a skin is between 0.1 mm and 3 mm and in some embodiments the skin has a thickness of between 0.8 and 2 mm.

A skin is readily bonded to a woven base through the application of elevated temperature and pressure to create a fusion bond therebetween, or through application of an adhesive layer intermediate therebetween. In some embodiments of the present invention, the woven base is exposed to an activation step of plasma or flame activation prior to skin bonding thereto.

In those skin compositions containing isocyanate functionality and without intending to be bound to a particular theory, it is believed that the isocyanate moiety covalently bonds with filaments of the woven base to achieve the high break and tear strengths associated with an inventive laminate.

A polyisocyante functionality is present in certain embodiments of the present invention. As used herein, a polyisocyanate is defined to include a molecule having at least two isocyanate functionalities. Exemplary diisocyanates include toluene diisocyanate (TDI), such as the 80:20 and the 65:35 mixtures of the 2,4- and 2,6-isomers, ethylene diisocyanate, propylene diisocyanate, methylene-bis (4-phenyl) isocyanate (also referred to as diphenylmethane diisocyanate or MDI), naphthalene diisocyanate (NDI), xylene diisocyanate (XDI), isophorone diisocyanate (IPDI), 3,3′-bistoluene-4,4′-diisocyanate, hexamethylene diisocyanate (HDI), hydrogenated DMI, hydrogenated XDI, and modified liquid MDI adducts, oligomeric HDI (e.g. dimer, trimer, etc.), oligomeric IPDI (e.g. dimer, trimer, etc.), naphthalene-1,5-diisocyanate, other oligomeric isocyanates, the polymeric isocyanates such as polyphenylene polymethylene isocyanate (PMDI), mixtures and derivatives thereof, and the like. In accordance with a particularly preferred embodiment of the invention, there is employed an isomeric mixture of 2,4- and 2,6-toluene diisocyanate in which the weight ratio of the 2,4-isomer to the 2,6-isomer is from about 60:40 to about 90:10, and more preferably from about 65:35 to about 80:20, as well as MDI.

The present invention overcomes a longstanding problem in the art associated with thermoplastic polyester elastomers that the drawing of such polymers into fibers or filaments tends to increase the modulus of elasticity of the resultant fiber or strand in the direction of orientation and also reduce elongation at break of the fibrous strand in the draw direction. As a result of this necessary processing step in order to form a woven base, conventional thermoplastic polyester elastomers have failed to achieve the required levels of break strength and tear strength need for a suspension seating system. Without intending to be bound to a particular theory, most degradation in properties associated with draw is associated with the differential rates of elongation of the comparatively flexible diol units of the elastomer chain relative to the more rigid segments of the thermoplastic polyester elastomer chains. In certain specific embodiments of the present invention, spun polyester yarn filaments are woven into the base to compensate for this change in properties. The spun polyester yarn filaments are sized to be comparable to those of the thermoplastic polyester elastomers. The spun polyester yarn filaments are utilized as warp or fill filaments, or a combination of both warp and fill filaments. In specific embodiments of the present invention, the spun polyester yarn filaments are sized to be within 20 strand diameter percent relative to those of the thermoplastic polyester elastomer filaments. The spun polyester yarn filaments represent between 0 and 30 percent of the filaments from which a woven base is formed. To impart uniformity in strength to a resultant flexible suspension laminate, spun polyester yarn fibers are present at regular intervals in both warp and fill directions.

In specific embodiments of the present invention, a foam layer is positioned in simultaneous contact with the woven base and an overlying skin to impart greater conformance between body surfaces of a user when an inventive flexible suspension laminate is used in a seating system. The foam layer is readily formed from either closed cell foams or opened celled foams. A polyurethane closed cell foam is particularly well suited for several seating applications while in still other embodiments a closed cell polyurethane foam inclusive of isisocyanate moieties is also used. It is appreciated that forms operative herein are also formed silicones, polyester, and soy foam. In some embodiments of the present invention having an intermediate foam layer, the foam is cured in place so as to penetrate into the woven base. The skin is joined with a foam embedding the woven base either concurrent with foam penetration into the woven base or subsequent thereto. A foam layer typically has a thickness between the skin and the woven base of between 0.5 and 10 mm and in certain embodiments foam layer has a thickness of between 1 and 3 mm. In some inventive embodiments, the foam has a knitted based that is joined to the woven base with an adhesive layer therebetween.

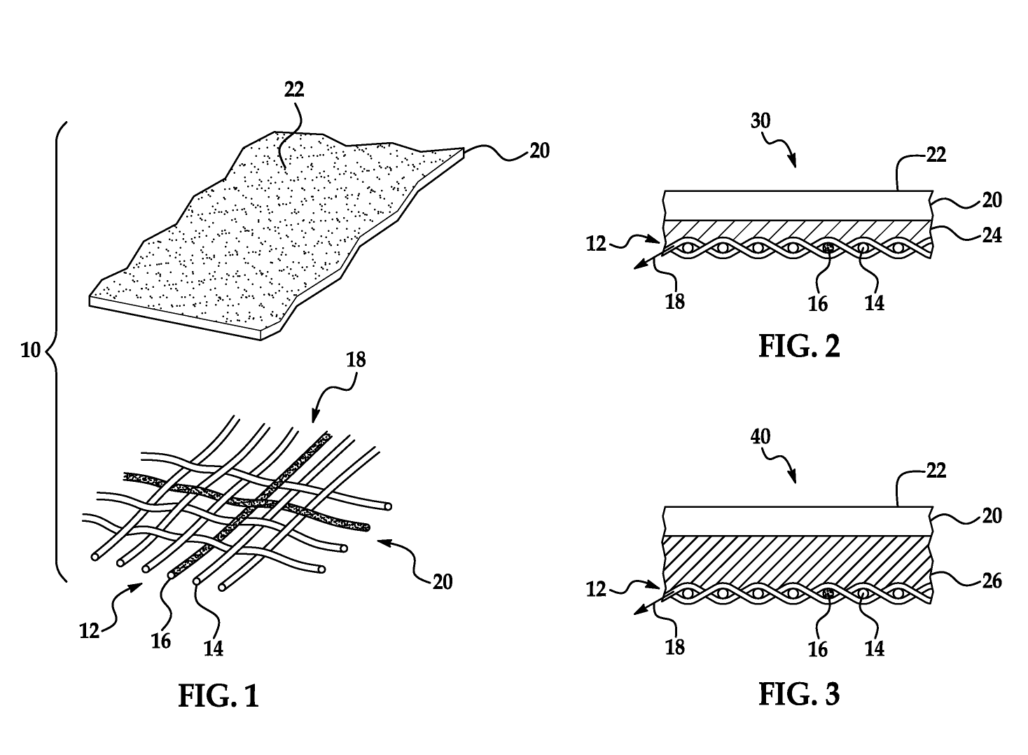

Referring now to FIGS. 1-3 in which like numerals used with reference to different Figures have the same meaning and are intended to be interpreted consistent with the above description of such terms. A woven base 12 is provided and includes thermoplastic polyester filaments 14 interwoven with spun polyester yarn filaments 16 the various filaments woven to define a warp access 18 a substantially orthogonal fill direction 20. The woven base 12 is directly bonded to a skin 20 having an outer surface 22 to form a flexible suspension laminate shown generally at 10 and FIG. 1. As noted, the outer surface 22 is readily textured to be simulative of leather or woven cloth among other textures as well as being formed as a flock.

A foam layer 24 is formed in simultaneous contact with skin 20 and a woven base 12 to form a laminate shown generally at 30 in FIG. 2. The foam 24 is either a closed cell foam or an opened celled foam. The foam layer 24 is readily formed of polyurethanes such as iso-isocyanate modified polyurethane; silicones; polyesters; and soy foams.

A foam layer in simultaneous contact with a woven base 12 and a skin 20 is readily formed in contact with the woven base 12 such that the foam precursors penetrate the woven base 12 as depicted at 26 in FIG. 3 but as otherwise compositionally the same as the foam depicted at reference numeral 24 in FIG. 2. A laminate in which intermediate foam layer 26 penetrates woven base 12 and simultaneously, or subsequently bonded to a skin 20 is depicted generally at 40 in FIG. 3.

A seating system is provided by suspending an inventive laminate on a tensioning frame or a prototypical frame defined by a pair of rods. A user sitting on a tensioned inventive laminate applies flexural tension thereto and after the user stands, the laminate returns to an original position. In alternate embodiments, an inventive laminate is sewn as a seating cover and filled with a frame and foam as part of conventional seat construction.

The present invention is further detailed with respect to the following examples that are exemplary of specific laminates of the present invention.

### EXAMPLE 1

A thermoplastic polyester elastomer woven base woven with a five harness sateen weave is formed with a warp end/in of 100; a fill yarn diameter of 0.37 mm and a coaxial monofilament diameter of 0.32 mm is heat sealed and is bonded to a dyed, textured surface densified polyurethane skin having the appearance of leather and a thickness of 0.7 mm, through simultaneous contact at elevated temperature and pressure, an inventive laminate is formed with a weight of 550 grams per square meter. A break strength for the resulting material is measured by ASTM D5034 of greater than 200 N/cm is measured in both warp and fill directions. A tear strength—tongue is measured by ASTM D2261 of 32 and 30 are measured in warp and fill directions, respectively.

### EXAMPLE 2

The thermoplastic polyester elastomer woven base of Example 1 is bonded to a textured surface densified polyvinyl chloride skin having a thickness of 0.7 mm to achieve inventive laminate with a weight of 550 grams per square meter. The break strength and tear strength—tongue are similar to those of Example 1.

### A COMPARATIVE EXAMPLE

A standard vinyl sheet used conventionally as a seating surface in a foam-filled vehicle seat has break and tear strength values as measured by the methods of Example 1 that are less than 60% of those measured for the laminate of Example 1.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A flexible suspension laminate comprising:
a woven base of thermoplastic polyester filaments interwoven with spun polyester yarn filaments;
a skin bonded to said woven base, said skin formed of a di-isocyanate modified polyurethane or polyvinyl chloride to achieve a warp break strength of greater than 200 Newton/centimeter and a fill break strength of greater than 200 Newton/centimeter.

2. The laminate of claim 1 wherein said thermoplastic polyester elastomer filaments are coaxial monofilaments.

3. The laminate of claim 1 wherein said thermoplastic polyester elastomer filaments has a diameter of between 0.15 and 1.5 millimeters.

4. The laminate of claim 1 wherein said spun polyester yarn filaments have a diameter of between 0.15 and 1.5 millimeters.

5. The laminate of claim 1 wherein said spun polyester yarn filaments are between 1 and 30 fiber percent of said woven base.

6. The laminate of claim 1 wherein said skin is bonded to said woven base with a fusion bond is independent of a contact adhesive.

7. The laminate of claim 1 wherein said skin is said di-isocyanate modified polyurethane.

8. The laminate of claim 1 wherein said skin has the outer surface being a flock.

9. The laminate of claim 1 wherein the outer surface is dyed.

10. The laminate of claim 1 wherein the outer surface has a texture simulative of leather or woven cloth.

11. The laminate of claim 1 wherein said woven base or said skin each independently includes one or more additives of a dyes, pigments, UV stabilizers, plasticizers, flame retardants, antimicrobials, or nanoparticles.

12. The laminate of claim 1 having a tongued warped tear strength of great than 30 Newtons/centimeter and a tongue fill tear strength of at least 28 Newtons/centimeter.

13. The laminate of claim 1 further comprising a foam layer and simultaneous contact with said woven base and said skin.

14. The laminate of claim 13 wherein said foam layer is a closed cell foam.

15. The laminate of claim 13 wherein said foam layer penetrates into said woven base.

16. The laminate of claim 13 wherein said foam layer is polyurethane.

17. The laminate of claim 16 wherein said polyurethane is di-isocyanate modified.

18. A seating system comprising:
a pair of rails; and
a laminate according to claim 1 suspended between said pair of rails.
